(19) United States
(12) Patent Application Publication
(10) Pub. No.: US 2001/0055442 A1
(43) Pub. Date: Dec. 27, 2001

(54) Optical wavelength-division multiplexing and demultiplexing by using a common optical bandpass filter for adding, dropping, or excanging one or more channels

(76) Inventors: Frank Whitehead, Orangevale, CA (US); Roger A. Hajjar, San Jose, CA (US)

Correspondence Address: BING AI, Fish & Richardson P.C., Suite 500, 4350 La Jolla Village Drive, San Diego, CA, 92122, US

(21) Appl. No.: 09/799,883

(22) Filed: Mar. 5, 2001

Related U.S. Application Data
(60) Provisional application No. 60/211,893, filed on Jun. 15, 2000.

(51) Int. Cl. G02B 6/293

(52) U.S. Cl. 385/24

(57) ABSTRACT

Techniques for using the same optical bandpass filter to add, drop, or exchange a WDM channel in a WDM device.

This application claims the benefit of U.S. Provisional Application No. 60/211,893, filed on Jun. 15, 2000.

### BACKGROUND

This application relates to optical wavelength-division multiplexing and demultiplexing of optical signals at different wavelengths.

Optical wavelength-division multiplexing (WDM) technique allows for simultaneous transfer of optical signals at different wavelengths, i.e., optical WDM channels, through a single optical link such as an optical fiber. A typical optical WDM system may need to add one or more WDM channels to a fiber that already carries one or more other WDM channels, or alternatively, to separate one or more WDM channels from other WDM channels in a fiber.

Optical bandpass filters at different WDM wavelengths may be used in various configurations to form WDM multiplexers for adding one or more WDM channels to a fiber, or to form WDM demultiplexers for dropping one or more WDM channels from a fiber. Such a bandpass filter may be designed to transmit light at a selected WDM wavelength while reflecting light at other WDM wavelengths. It is generally desirable to reduce the number of such bandpass filters in a WDM multiplexer or demultiplexer.

### SUMMARY

One embodiment of a device of the present disclosure includes a first lens and a second lens spaced from each other and aligned to define a common optical axis. The first lens has a first focal plane on one side of the first lens opposite to a side where the second lens is located. The second lens has a second focal plane on one side of the second lens opposite to a side where the first lens is located.

The device also includes an optical bandpass filter located between the first and the second lenses and operable to transmit light at a selected transmitting wavelength and to reflect light at other wavelengths. There are first and second fiber ports located at the first focal plane and symmetrically displaced from the common optical axis in a plane that includes the optical axis so that a beam at a wavelength different from the transmitting wavelength from the first fiber port is reflected by the optical bandpass filter and is focused onto the second fiber port by the first lens and vice versa.

The device further includes third and fourth fiber ports at the second focal plane and symmetrically displaced from the optical axis in the same plane in which the first and the second fiber ports are located. The positions of the third and fourth fiber ports are selected so that a beam at the transmitting wavelength from the first fiber port is received by the fourth fiber port and vice versa and a beam at the transmitting wavelength from the second fiber port is received by the third fiber port and vice versa.

### BRIEF DESCRIPTION OF THE DRAWINGS

FIG. 1 shows one embodiment of a 4-port WDM element that uses a common optical bandpass filter for adding, dropping, or exchanging a WDM channel, where the insert shows the reflective and transmission spectra of the optical bandpass filter.

FIG. 2A shows one embodiment of an 8-port WDM element that uses a common optical bandpass filter.

FIG. 2B shows another embodiment of an 8-port WDM element that uses a common optical bandpass filter.

FIG. 3 shows an exemplary WDM device that combines two or more 4-port WDM elements in FIG. 1 to add, drop, or exchange two or more WDM channels.

### DETAILED DESCRIPTION

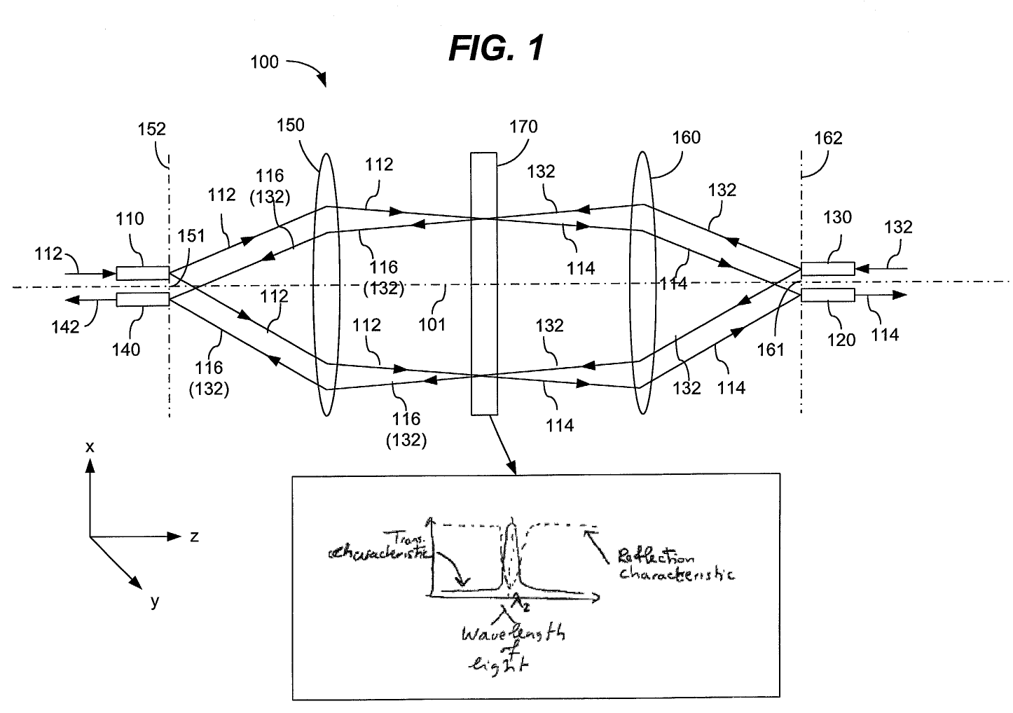

FIG. 1 shows one embodiment of a 4-port WDM element 100 which includes an optical bandpass filter 170, two collimator lenses 150 and 160, an input fiber port 110, an output fiber port 140, a drop fiber port 120, and an add fiber port 130. A xyz coordinate system is used in the following description for explaining the relative spatial positions of various components. The optical layout of the WDM element 100 is designed to use the same bandpass filter 170 for both adding and dropping a WDM channel at a selected WDM wavelength.

The bandpass filter 170 is designed to have two opposing planar surfaces and operates to transmit light at a selected center wavelength, e.g., at a wavelength λ₂, with a given bandwidth and to reflect light at other wavelengths. The planar surfaces in the fiber 170 are implemented so that the reflective angle of the reflected light is equal to the incident angle of the input light to the filter to form an optically symmetric configuration for the respective pair of fiber ports at a focal plane. The insert figure in FIG. 1 illustrates the reflective and transmissive spectra of the filter 170. The transmissive bandwidth is sufficiently narrow to transmit one WDM channel while reflecting other WDM channels. Examples for the filter 170 include, among others, a thin-film multi-layer interference filter or a Fabry-Perot filter with two planar reflectors.

The two collimating lenses 150 and 160 are spaced from each other and are aligned to define a common optic axis 101 along the z direction of the xyz coordinate system. In general, the lenses 150 and 160 may not be necessarily the same and may have different focal lengths. However, it is preferred that the lenses 150 and 160 are substantially identical to each other and have the same focal length. This ensures that the optical layout in the device 100 is optically symmetric to match the generally identical numerical apertures of the fiber ports 110, 120, 130, and 140. The filter 170 is located between the lenses 150 and 160 and is orientated so that the optical axis of the lenses 150 and 160 is substantially perpendicular to the filter 170.

The input and output fiber ports 110 and 140 are located in the xz plane to place their end facets in the focal plane 152 of the lens 150 so that their output divergent beams can be substantially collimated by the lens 150. Notably, the facets of the fiber ports 110 and 140 in the focal plane 152 are off the optic axis 101 and symmetrically located on opposite sides of the focal point 151 where the optic axis 101 and the focal plane 152 intercept so that an input beam 112 at any wavelength different from λ₂, after being reflected by the filter 170, will be focused onto the end facet of the output fiber port 140 due to the symmetry. The spacing between the ports 110 and 140 is selected so that the center wavelength of the transmissive band of the filter 170 is at the desired wavelength λ₂.

The drop and add fiber ports 120 and 130 are essentially optical counterparts of the fiber ports 110 and 140, respectively. They are also located in the xz plane but are positioned to place their end facets in the focal plane 162 of the other lens 160. Similar to the symmetric arrangement of the ports 110 and 140, the facets of the fiber ports 120 and 130 in the focal plane 162 are off the optic axis 101 and symmetrically located on opposite sides of the focal point 161 where the optic axis 101 and the focal plane 162 intercept. Hence, an input beam 132 at any wavelength different from λ₂, after being reflected by the filter 170, will be focused onto the end facet of the dropt fiber port 120.

In particular, the drop fiber port 120 is off the optic axis 101 in the opposite direction of the input fiber port 110 so that an input beam 112 at the wavelength λ₂ from the input fiber port 110 will be directed to transmit through the lens 150 and the filter 170 and be focused to the end facet of the drop fiber port 120. The add fiber port 130 is off the optic axis 101 in the opposite direction of the output fiber port 140 so that an input beam 132 at the wavelength λ₂ from the add fiber port 130 will be directed to transmit through the lens 160 and the filter 170 and be focused to the end facet of the output fiber port 140. The spacing between the ports 120 and 130 is sufficiently small so that their output divergent beams can be substantially collimated by the lens 160.

The WDM element 100 may be controlled to operate as follows. Assume that the input fiber port 110 receives an input beam 112 having WDM channels at different WDM wavelengths λ₁, λ₂, λ₃, . . . , respectively. The beam 112 is then received by the lens 150 and is collimated. The filter 170 receives and processes the collimated beam 112 by reflecting the WDM channels at the wavelengths λ₁, λ₃, λ₄, . . . as a reflected beam 116 and transmitting the WDM channel at λ₂ as a transmitted collimated beam 114 to the lens 160. The reflected collimated beam 116 is focused by the lens 150 onto the end facet of the output fiber port 140 as at least a part of the output 142 of the WDM element 100. The lens 160 focuses the transmitted beam 114 onto the end facet of the drop fiber port 120 to produce the drop channel 114. The above process performs the drop operation of the WDM element 100.

The WDM element 100 may also use the same filter 170 to add a new channel at the transmitting wavelength λ₂ of the filter 170 to the output 116 at the output fiber port 140. This is accomplished by sending an input beam 132 at the wavelength λ₂ that carries the new channel into the WDM element 100 at the add fiber port 130. The beam 132 is received by the lens 160 and is collimated. The collimated beam 132 transmits through the filter 170 and combines with the reflected beam 116. Hence, after transmitting through the filter 170, the beam 132 is processed essentially in the same way as the reflected beam 116, i.e., being focused by the lens 150 onto the end facet of the output fiber port 140 as a part of the output 142. If the input signal 112 does not have a channel at λ₂, the signal 132 will be added at λ₂; if the input signal does have an input channel λ₂, this input channel will be dropped by the filter 170 at the drop fiber port 120 and in exchange, the new channel 132 at λ₂ will be substituted. Therefore, the WDM element 100 is operable to add a WDM channel at λ₂ to the output fiber port 140 when the input beam 112 has a void at the wavelength λ₂, to drop an input WDM channel at λ₂, or to exchange the input channel at λ₂ with a new channel at λ₂ from the add fiber port 130.

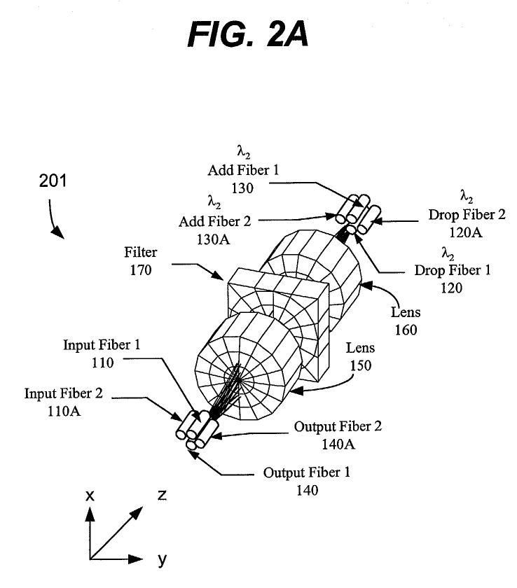

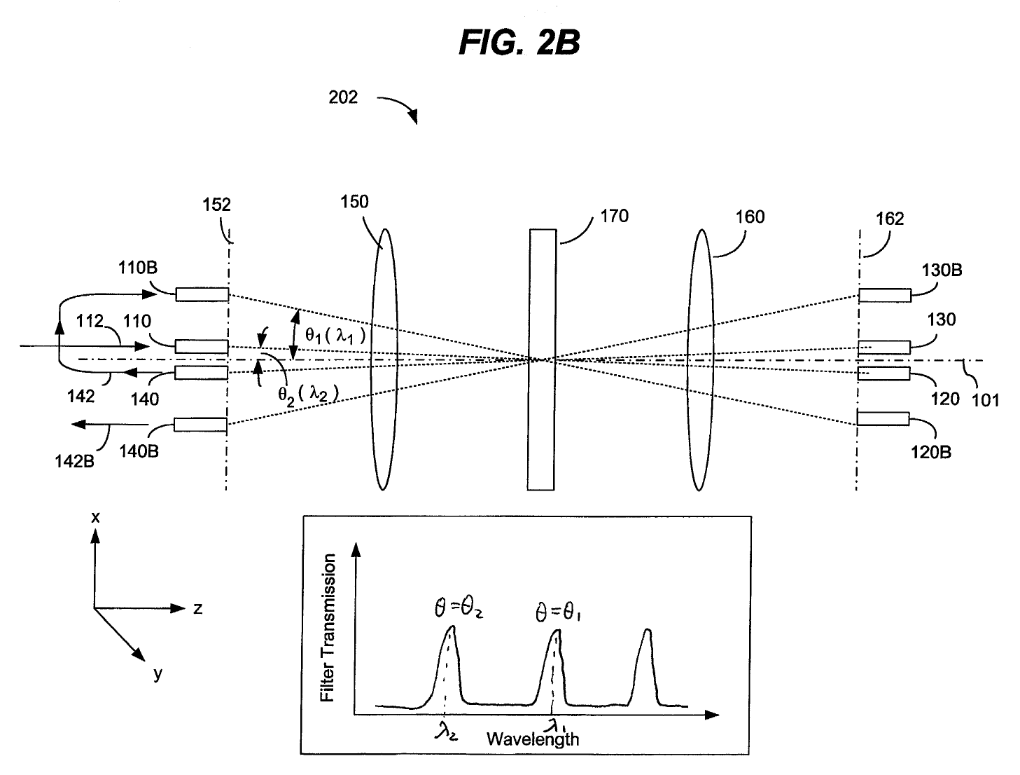

FIG. 2A shows another embodiment 201 based on the filtering mechanism in FIG. 1. At each of the focal planes 152 and 162, another pair of fiber ports are symmetrically added with respect to the optical axis 101 to form another 4-port WDM element by sharing the same lenses 150, 160 and the same filter 170 with the 4-port WDM element 100. To avoid optical cross talk, the added fiber ports 110A, 140A at the focal plane 152, and the added fiber ports 120A and 130A at the focal plane 162 are in the yz plane which is rotated 90 degree from the xz plane. The spacing between the fiber ports 110A and 140A and between 120A and 130A may be equal to the spacing between the fiber ports 110 and 140 and between the fiber ports 120 and 130. Hence, the fiber port 110A may receive another set of WDM channels to drop a channel of wavelength λ₂ at the fiber port 120A, or to add a new channel of wavelength λ₂ at the fiber port 130A. The fiber port 140A is used to output the newly-processed WDM channels. This operation can be carried out independently from the operation in the fiber ports 110, 120, 130, and 140, and hence can increase the processing capacity without requiring additional filters and lenses.

As long as the optical cross talk is below an acceptable level, two or more sets of pairs of fiber ports may be similarly added to the device 100 to further increase the processing capacity. In the case of three 4-port WDM elements sharing the lenses 150, 160 and the filter 170, for example, three pairs of fiber ports are symmetrically formed around the optical axis 101 at each focal plane with two adjacent pairs form an angle of 60 degrees.

Additional pairs of fiber ports may also be added to the focal planes 152 and 162 with different relative spacings. FIG. 2B shows one embodiment 202 where a pair of fiber ports 110B and 140B are added to the focal plane 152 and another symmetric pair of fiber ports 120B and 130B are added to the focal plane 162. In this configuration, the spacing between the fiber ports 110B and 140B is selected to be greater than that of the fiber ports 110 and 140 so that the incident angle θ₁ of the each of fiber ports 110B, 120B, 130B, and 140B to the filter 170 is greater than the incident angle θ₂ of the fiber ports 110, 120, 130, and 140.

For interference filters and planar mirror Fabry-Perot filters, the center wavelength of the transmissive band is known to shift with the incident angle of an optical beam to the filter. Therefore, as illustrated in the insert spectrum chart in FIG. 2B, the fiber 170 exhibits a transmissive wavelength λ₁ at the incident angle θ₁ for fiber ports 110B through 140B and a different, shorter transmissive wavelength λ₂ at the incident angle θ₂ for fiber ports 110 through 140. The relative spacing between two fiber ports in each pair, i.e., the angular difference, may be selected so that different transmissive wavelengths for different incident angles coincide with the desired WDM channel wavelengths, e.g., the ITU wavelengths. Hence, the device 202 is operable to add, drop, or exchange a channel at λ₁ by using the fiber ports 110B through 140B and to add, drop, or exchange a channel at λ₂ by using the fiber ports 110 through 140. In effect, a single filter 170 under this configuration can operate as two separate filters at two different transmissive wavelengths.

The above use of different pairs of fiber ports with different spacings to add, drop, or exchange channels with different wavelengths by using the same filter 170 may be expanded for adding, dropping or exchanging three or more different wavelengths. In FIG. 2B, all fiber ports are located in the same xz plane. Alternatively, the fiber ports 110B through 140B may be placed in a different plane such as the yz plane. Hence, the device 201 in FIG. 2A may be modified to add, drop, or exchange two different wavelengths with the same filter 170 if the spacing between the fiber ports 110A and 140A and between 120A and 130A in the yz plane is different from the spacing between the fiber ports 110A and 140A and between 120A and 130A in the yz plane.

Two different input signals each having multiple WDM channels may be separately fed into the input fiber ports 110 and 110B and be separated processed at the two different wavelengths. The resultant output signals may be generated at the output fiber ports 140 and 140B, respectively. Alternatively, as illustrated in FIG. 2B, the output signal 142 at the output port 140, produced by processing the input signal 112 to the input fiber port 110 through adding, dropping, or exchanging at the wavelength λ₂, may be fed back to the input fiber port 110B to be further processed at the wavelength λ₁ to produce a new output signal 142B at the fiber port 140B. If the device 202 has other fiber ports for processing at additional wavelengths, the above feedback process can be repeated to use the same filter 170 to add, drop, or exchange channels at various wavelengths.

In general, the technique of using different sets of fiber ports in different planes that includes the optic axis 101 as shown in FIG. 2A and the technique of using different set if fiber ports with different relative spacings as shown in FIG. 2B may be combined to increase the number of channels to be processed by using a single filter 170 and a single pair of lenses 150 and 160.

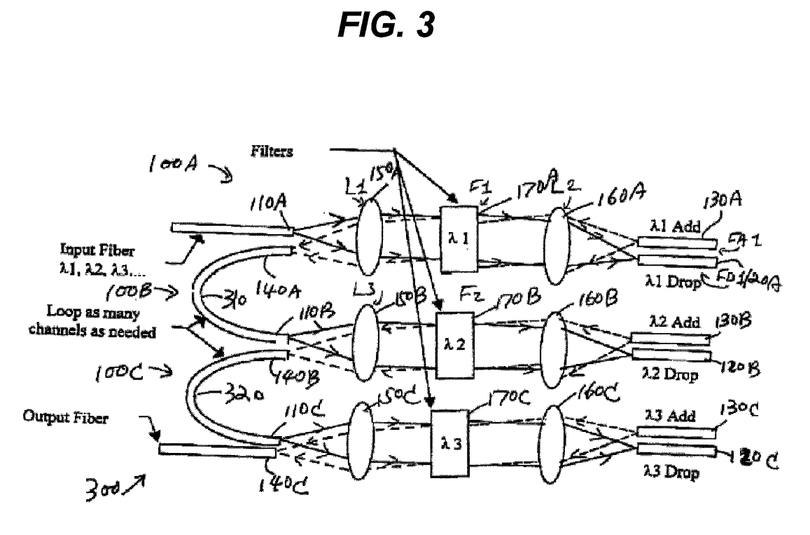

The above WDM elements based on the individual or combinations of the configurations shown in FIGS. 1, 2A, and 2B may be used as building blocks to form a variety of WDM devices by combining two or more such WDM elements. FIG. 3 shows one exemplary WDM device 300 that uses three different WDM elements 100A, 100B, and 100C based on the WDM element 100 in FIG. 1. The WDM elements 100A, 100B, and 100C are configured to have optical filters for transmitting wavelengths λ₁, λ₂, and λ₃, respectively. This may be achieved by using filters with different designs so that the transmissive wavelengths are different for different filters at the same incident angle. Alternatively, the three filters are identical but the relative spacing of two fiber ports in each pair varies among WDM elements 100A, 100B, and 100C so that optical incident angles are different and hence the transmissive wavelengths. A fiber 310 is coupled to direct signals from the output fiber port 140A of the WDM element 100A into the input fiber port 100B of the WDM element 100B. Another fiber 320 is coupled to direct signals from the output fiber port 140B of the WDM element 100B into the input fiber port 110C of the WDM element 100C. This device 300 allows for dropping, adding, or exchanging any channels at the wavelengths λ₁, λ₂, and λ₃. In principle, any number of such WDM elements may be so combined to provide versatile operations for adding, dropping, or exchanging channels at different wavelengths.

Although the present disclosure only includes a few embodiments, other modifications and enhancements may be made without departing from the following claims.

What is claimed is:

1. A device, comprising:
a first lens and a second lens spaced from each other and aligned to define a common optical axis, said first lens having a first focal plane on one side of said first lens opposite to a side where said second lens is located and said second lens having a second focal plane on one side of said second lens opposite to a side where said first lens is located;
an optical bandpass filter located between said first and said second lenses and operable to transmit light at a transmitting wavelength and to reflect light at other wavelengths;
first and second fiber ports placed in said first focal plane and symmetrically displaced from said common optical axis in a plane that includes said common optical axis so that a beam from said first fiber port, upon reflection by said optical bandpass filter, is focused onto said second fiber port by said first lens and vice versa; and
third and fourth fiber ports placed in said second focal plane and symmetrically displaced from said common optical axis in said plane so that a beam at said transmitting wavelength from said first fiber port transmits through said first lens, said optical bandpass filter, said second lens to reach said fourth fiber port and vice versa and a beam at said transmitting wavelength from said third fiber port transmits through said second lens, said optical bandpass filter, and said first lens to reach said second fiber port and vice versa.

2. The device as in claim 1, further comprising:
a third lens and a fourth lens spaced from each other and aligned to define another common optical axis, said third lens having a third focal plane on one side of said third lens opposite to a side where said fourth lens is located and said fourth lens having a fourth focal plane on one side of said second lens opposite to a side where said third lens is located;
a second optical bandpass filter located between said third and said fourth lenses and operable to transmit light at a second selected transmitting wavelength and to reflect light at other wavelengths;
fifth and sixth fiber ports at said third focal plane and symmetrically displaced from said another common optical axis in a plane that includes said another common optical axis so that a beam from said fifth fiber port, upon reflection by said second optical bandpass filter, is focused onto said sixth fiber port by said third lens and vice versa;
seventh and eighth fiber ports at said fourth focal plane and symmetrically displaced from said another common optical axis in said plane so that a beam from said fifth fiber port at said second transmitting wavelength transmits through said third lens, said second optical bandpass filter, and said fourth lens to reach said eighth fiber port and vice versa and a beam from said seventh fiber port at said second transmitting wavelength transmits through said fourth lens, said second optical bandpass filter, and said third lens to reach said sixth fiber port and vice versa; and
a connecting fiber coupled between said second and said fifth fiber ports.

3. The device as in claim 1, wherein said optical bandpass filter exhibits different values for said transmitting wavelength at different optical incident angles, and further comprising:
fifth and sixth fiber ports at said first focal plane and symmetrically displaced from said common optical axis in another plane that includes said common optical axis so that a beam from said fifth fiber port, upon reflection by said optical bandpass filter, is focused onto said sixth fiber port by said first lens and vice versa, said fifth and said sixth fiber ports being spaced from each other at a distance different from a distance between said first and said second fiber ports; and
seventh and eighth fiber ports at said second focal plane and symmetrically displaced from said common optical axis in said another plane so that a beam from said fifth fiber port at a second transmitting wavelength transmits through said first lens, said optical bandpass filter, and said second lens to reach said eighth fiber port and vice versa, and a beam from said seventh fiber port at said second transmitting wavelength transmits through said second lens, said optical bandpass filter, and said first lens to reach said sixth fiber port and vice versa.

4. The device as in claim 3, wherein said plane and said another plane form a non-zero angle with respect to each other.

5. The device as in claim 4, wherein said non-zero angle is about 90 degrees.

6. The device as in claim 3, further comprising a connecting fiber coupled between said second and said fifth fiber ports.

7. The device as in claim 3, wherein said plane and said another plane coincide with each other.

8. The device as in claim 1, further comprising:
fifth and sixth fiber ports at said first focal plane and symmetrically displaced from said common optical axis in another plane that includes said common optical axis so that a beam from said fifth fiber port, upon reflection by said optical bandpass filter, is focused onto said sixth fiber port by said first lens and vice versa, said fifth and said sixth fiber ports being spaced from each other at a distance substantially equal to a distance between said first and said second fiber ports; and
seventh and eighth fiber ports at said second focal plane and symmetrically displaced from said common optical axis in said another plane so that a beam from said fifth fiber port at said transmitting wavelength transmits through said first lens, said optical bandpass filter, and said second lens to reach said eighth fiber port and vice versa, and a beam from said seventh fiber port at said transmitting wavelength transmits through said second lens, said optical bandpass filter, and said first lens to reach said sixth fiber port and vice versa.

9. The device as in claim 8, wherein said plane and said another plane form a non-zero angle with respect to each other.

10. The device as in claim 9, wherein said non-zero angle is about 90 degrees.

11. The device as in claim 1, wherein said optical bandpass filter includes a thin-film interference filter or a Fabry-Perot filter.

12. A device, comprising:
a first lens and a second lens spaced from each other and aligned to define an optical axis, said first lens having a first focal plane on one side of said first lens opposite to a side where said second lens is located and said second lens having a second focal plane on one side of said second lens opposite to a side where said first lens is located;
an optical bandpass filter located between said first and said second lenses and operable to transmit light at a transmitting wavelength and to reflect light at other wavelengths;
first and second fiber ports placed in said first focal plane and symmetrically displaced from said optical axis so that a beam from said first fiber port, upon reflection by said optical bandpass filter, is focused onto said second fiber port by said first lens and vice versa;
third and fourth fiber ports placed in said second focal plane and symmetrically displaced from said optical axis so that a beam from said first fiber port at said transmitting wavelength transmits through said first lens, said second lens, and said optical bandpass filter to reach said fourth fiber port and vice versa and a beam from said third fiber port at said transmitting wavelength transmits through said second lens, said optical bandpass filter, and said first lens to reach said second fiber port and vice versa;
fifth and sixth fiber ports at said first focal plane and symmetrically displaced from said optical axis so that a beam from said fifth fiber port, upon reflection by said optical bandpass filter, is focused onto said sixth fiber port by said first lens and vice versa; and
seventh and eighth fiber ports at said second focal plane and symmetrically displaced from said optical axis so that a beam from said fifth fiber port, if transmissive to said optical bandpass filter, transmits through said first lens, said optical bandpass filter, and said second lens to reach said eighth fiber port and vice versa, and a beam from said seventh fiber port, if transmissive to said optical bandpass filter, transmits through said second lens, said optical bandpass filter, and said first lens to reach said sixth fiber port and vice versa.

13. The device as in claim 12, wherein said first and said second fiber ports have a spacing different from a spacing between said fifth and said sixth fiber ports.

14. The device as in claim 13, further comprising a fiber connected between said second and said fifth fiber ports to for an optical path.

15. The device as in claim 12, wherein said first and said second fiber ports have a spacing substantially equal to a spacing between said fifth and said sixth fiber ports.

16. The device as in claim 15, wherein said first, said second, said third, and said fourth fiber ports are in a common plane different from a plane in which said fifth, said sixth, said seventh, and said eighth fiber ports are located.

17. A method, comprising:
directing an input optical signal with a plurality of WDM channels to a first side of an optical bandpass filter which transmits light at a selected WDM channel wavelength and reflects other channels;
receiving a transmitted optical signal at said selected WDM channel at a second, opposing side of said optical bandpass filter as a drop channel;
using a reflection of said input optical signal from said first side of said optical bandpass filter as an output optical signal; and
directing a second optical input signal at said selected WDM channel wavelength as an add channel to said second, opposing side of said optical bandpass filter so that said second optical input signal transmits through said optical bandpass filter and merges with said reflection as a part of said output optical signal.

18. The method as in claim 17, wherein said optical bandpass filter exhibits different values for said selected WDM channel wavelength at different optical incident angles, and further comprising:
directing another input optical signal with a plurality of WDM channels to said first side of said optical bandpass filter at a second incident angle different from a first incident angle of said input optical signal to drop a WDM channel at a second selected WDM channel wavelength;
using a reflection of said another input optical signal from said first side of said optical bandpass filter as a second output optical signal; and
adding a new WDM channel to said second output optical signal by directing a third optical input signal at said second selected WDM channel wavelength to said second, opposing side of said optical bandpass filter at said second incident angle so that said third optical input signal transmits through said optical bandpass filter and merges with said reflection of said another input optical signal.

19. The method as in claim 18, further comprising directing said second output optical signal back to said optical bandpass filter as said input optical signal.

20. The method as in claim 17, wherein said optical bandpass filter has planar surfaces on both said first and said second sides so that an incident beam incident at an incident angle, if reflected, is reflected at an reflective angle identical said incident angle.
